(19) United States
(12) Patent Application Publication
(10) Pub. No.: US 2010/0145809 A1
(43) Pub. Date: Jun. 10, 2010

(54) APPLICATIONS FOR AUCTION FOR EACH INDIVIDUAL AD IMPRESSION

(75) Inventors: Jason J. A. Knapp, Solana Beach, CA (US); Fabrizio Blanco, Los Angeles, CA (US)

Correspondence Address: GATES & COOPER LLP;HOWARD HUGHES CENTER, 6701 CENTER DRIVE WEST, SUITE 1050, LOS ANGELES, CA, 90045, US

(73) Assignee: FOX AUDIENCE NETWORK, INC., Santa Monica, CA (US)

(21) Appl. No.: 12/701,225

(22) Filed: Feb. 5, 2010

Related U.S. Application Data
(63) Continuation-in-part of application No. 11/959,385, filed on Dec. 18, 2007.
(60) Provisional application No. 60/876,026, filed on Dec. 19, 2006.
(60) Provisional application No. 61/293,430, filed on Jan. 8, 2010.

(51) Int. Cl. G06Q 30/00

(52) U.S. Cl. 705/14.71

(57) ABSTRACT

A method and system provide the ability to select media content and an advertisement to be displayed by a user/user device. In response to a received request for media content (e.g., by a broadcast programming provider or content provider) from a particular user device (e.g., a subscriber receiver station or thin client device), a real-time auction is conducted to select a winning advertisement. The auction includes the dynamic request and receipt of a bid, a determination of the winning bid, and the providing of the winning advertisement to be displayed with the media content.

### CROSS-REFERENCE TO RELATED APPLICATIONS

This application in a continuation-in-part of and claims the benefit under 35 U.S.C. Section 120 of the following co-pending and commonly-assigned U.S. utility patent application(s), which is/are incorporated by reference herein:

Utility application Ser. No. 11/959,385, filed Dec. 18, 2007, by Jason J. A. Knapp and Fabrizio Blanco, entitled “Auction for Each Individual Ad Impression”, attorneys' docket number 241.4-US-U1, which application claims the benefit under 35 U.S.C. Section 119(e) of a provisional application U.S. Ser. No. 60/876,026 filed on Dec. 19, 2006, entitled “Auction For Each Individual Ad Impression,” Attorney Docket No. 241.4-US-P1.

This application is related to the following co-pending and commonly-assigned patent application, which application is incorporated by reference herein:

U.S. Provisional Patent Application Ser. No. 61/293,430, entitled “Content Security for Real-Time Bidding”, attorney docket no. 241.6-US-P1, filed on Jan. 8, 2010.

### BACKGROUND OF THE INVENTION

1. Field of the Invention

The subject matter described herein relates to data processing and, in particular, presenting an ad based on an evaluation of bids.

2. Description of the Related Art

Advertisers try to reach consumers in a variety of ways. One of those ways is through web-based advertising on the Internet. A common way for advertisers to reach consumers on the Internet is by presenting ads in web sites, either as a pop-up window or embedded within the web page being viewed by the consumer. Web sites, such as MSN, MySpace, and Yahoo, rely on advertising as an increasingly important source of revenue. But unless advertisers realize returns from advertising on a web site (e.g., in the form of a purchase or a visit to the advertiser's web site), advertisers may reduce or even stop advertising on the web site. Accordingly, web sites have an interest in selecting an ad that generates revenue for the web site and provides some form of return to the advertiser.

Advertisers may further try to reach consumers by presenting commercials or advertising in broadcast programming (e.g., on televisions) or on portable devices (e.g., personal digital assistants, cellular phones, etc.). Similar to advertising on websites, advertisers expect a return on their investment associated with placing advertisements into or part of programming. If the advertiser doesn't realize a return, the advertiser will be less inclined to (or will no longer) purchase advertisements from the broadcast network (thereby decreasing a broadcast networks revenue). Accordingly, broadcast networks (e.g., FOX™, CBS™, cable networks, etc.) have a desire to select ads that generate revenue for the network as well as provide some sort of return to the advertiser.

Similarly, the wide-spread adoption of small thin client devices such as cellular phones has expanded the capability to access the internet and receive advertisements on such devices. It is desirable for cellular or local networks on which the thin client devices are operating to select ads that generate revenue for the network as well as provide a return on investment to the advertiser. Alternatively, the content provider may have such desires.

Accordingly, what is needed is the capability to determine an advertisement that is displayed to a user based on information known about the user at the time the advertisement is displayed. Such capabilities are not available in prior art web based advertising implementations.

### SUMMARY OF THE INVENTION

The subject matter described herein relates to systems, methods, and articles including computer-readable media to enable an auction (e.g., bidding) for presenting advertisements as part of a broadcast program as well as part of any content that can be streamed to or displayed by a user.

In one or more embodiments, a dynamic real-time auction is conducted between a server (that will deliver the advertisement to an end-user device) and bidding advertisers. Alternatively, the end-user device may conduct the real-time auction by directly communicating with the bidders. The real-time auction may be conducted in a variety of environments including a broadcast programming environment between a broadcast programming provider and subscriber receiver station, or alternatively, between a thin client device and a content provider. In any environment, the real-time dynamic auction capabilities provide advantages over prior art advertising techniques.

Further, in one aspect, there is provided a method for polling, by a script at a browser, one or more servers by sending messages to the one or more servers. The one or more messages may solicit one or more bids for presenting an ad at the browser. The one or more messages may also enable access to information at the browser. The information may be relevant to the one or more servers making the one or more bids. The script may receive one or more responses from the one or more servers. The one or more responses include the one or more bids. The script may also evaluate the one or more bids, and select one of the bids based on the evaluation.

In some variations, the servers are solicited for the bids thereby enabling the servers to respond to the bid requests. The polling may also enable access to information included in one or more cookies at the browser. The messages may include information representative of a minimum amount. The evaluation may determine whether at least one of the bids exceeds a minimum bid amount. A default bid may also be evaluated as one of the bids. A default bid may be defined as one of the bids, when the bids do not exceed a value representative of a minimum bid amount. A default bid may be defined as one of the bids, when at least one of the bids is not received. The default bid corresponding to the default ad may be selected. The script may be implemented as JavaScript. A webpage including the script may be accessed (i.e., by the browser) and then provided to the browser. When a second access (by the browser) occurs, another script indicating the location of another server capable of evaluating bids may be provided. The one or more servers may evaluate context information associated with the ad to determine whether to bid on the ad. The polling may be implemented for each opportunity to place an ad. The script may include at least one of the following: a location of the one or more servers, a location of a default ad, and a factor to adjust at least one of the bids. The ad corresponding to the selected bid may be presented.

In an interrelated aspect, there is provided a method for polling one or more servers by sending messages from a user interface to the one or more servers. The one or more messages may solicit one or more bids for presenting an ad at the user interface. At the user interface, an ad may be provided. The provided ad may be selected based on the one or more bids.

Articles are also described that comprise a tangibly embodied machine-readable medium (e.g., a computer-readable medium) embodying instructions that, when performed, cause one or more machines (e.g., computers, etc.) to result in operations described herein. Similarly, computer systems are also described that may include a processor and a memory coupled to the processor. The memory may include one or more programs that cause the processor to perform one or more of the operations described herein.

In an interrelated aspect, there is provided a method for receiving (at the browser) a message generated by a script. The message may be used to poll a server and solicit a bid for presenting an ad at the browser. Accordingly, the message enables access to information at the browser (e.g., utilizing cookies via the communication between the browser and the server making the bid). The information may be relevant to the server making the bid. The received message may be forwarded.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

Referring now to the drawings in which like reference numbers represent corresponding parts throughout:

FIG. 1 is a block diagram illustrating a system for presenting ads based on bids;

FIG. 2 is a process flow diagram illustrating a method for presenting ads based on bids;

FIG. 3 is a process flow diagram illustrating a method for presenting ads based on bids;

FIG. 4 depicts a messages exchange when bidding for ad placement;

FIG. 5 is an overview of a broadcast programming environment that can be used in accordance with one or more embodiments of the invention;

FIG. 6 is a block diagram of an integrated receiver/decoder (IRD) that can be utilized in accordance with one or more embodiments of the invention;

FIG. 7 illustrates an exemplary network configuration that could be used to provide inter-network communications in accordance with one or more embodiments of the invention;

FIG. 8 illustrates a phone system utilized in accordance with one or more embodiments of the invention; and

FIG. 9 is a flow chart illustrating the logical flow for selecting media content (e.g., an advertisement) to be displayed by a user in accordance with one or more embodiments of the invention.

### DETAILED DESCRIPTION OF THE PREFERRED EMBODIMENTS

In the following description, reference is made to the accompanying drawings which form a part hereof, and which is shown, by way of illustration, several embodiments of the present invention. It is understood that other embodiments may be utilized and structural changes may be made without departing from the scope of the present invention.

An advertising impression is an individual instance when an advertisement (ad) is shown to a particular user. For example, when a user selects a web page to view, that instance of the web page may provide one or more opportunities for an ad impression (also referred to as an “impression”). If the user selects to view another web page, the other web page may provide one or more additional opportunities for an ad impression, i.e., another instance when an ad can be presented to the user. The subject matter described herein relates to systems, methods, and articles including computer-readable media to enable an auction (e.g., bidding) for presenting ads for each impression as the impression (e.g., a web page) is served and/or rendered.

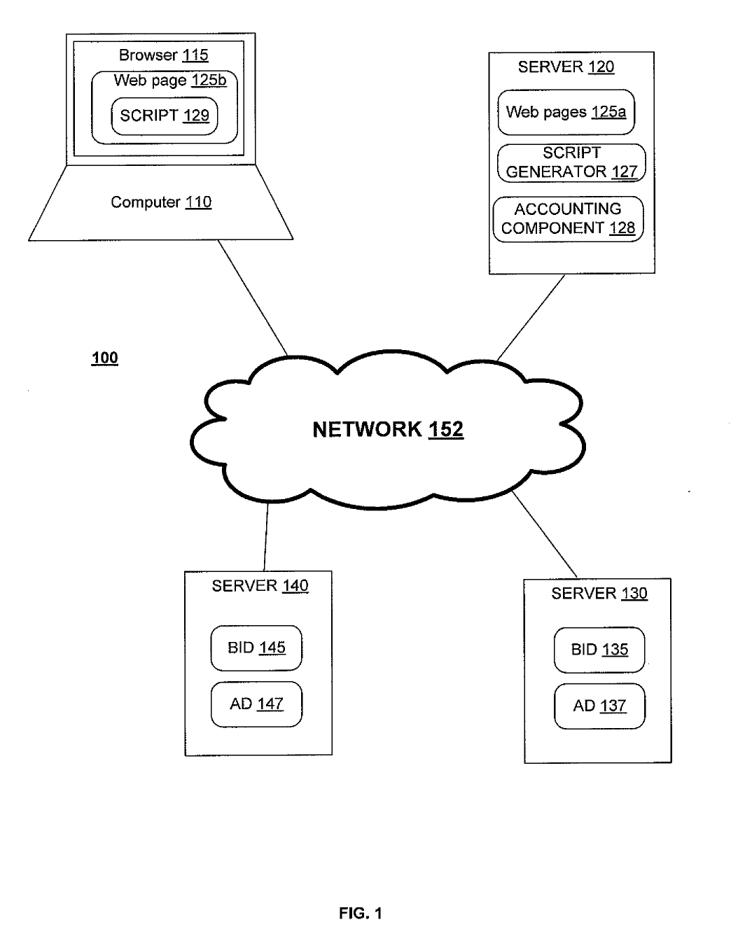

FIG. 1 depicts a system 100 including a computer 110 coupled to servers 120-140 through a network 152, such as the Internet or any other communications medium. The computer 110 includes a browser 115. A browser (also known as a web browser) is a software application used to locate and display information content, such as web pages. A web page is a document on the web. For example, a web page may be implemented as HTML (Hyper Text Markup Language) files and/or any related files for scripts and graphics, as well as hyperlinks to other documents on the web.

The server 120 may include content information, such as one or more web pages 125a or other information content (e.g., music, television, video, and the like), all of which can be provided to browser 115. The server 120 may include a script generator 127 for generating scripts and an accounting component 128 for tracking the number of times an ad is provided to a browser for presentation and tracking any clicks on that ad.

Although FIG. 1 depicts script generator 127 and accounting component 128 included within server 120, script generator 127 and/or accounting component 128 may be located anywhere and in multiple locations. For example, in some implementations, server 120 may redirect the request to one or more other servers, such as server 130, server 140, and/or an ad server, i.e., a server that stores, links, and/or delivers ads. When that is the case, script generator 127 at the other server 130 or 140 provides script 129, which may be inserted into information, such as web page 125b. Moreover, the other server 130/140 may be able to serve ads to browser 115 as well. Moreover, although servers 120-140 are depicted as individual servers, each of servers 120-140 may be implemented as a plurality of servers.

The script generator 127 generates scripts, such as script 129, that are embedded in a web page, such as web page 125b, and provided to browser 115. The script 129 polls servers 130 and 140 to solicit an indication of whether servers 130 and 140 are interested in presenting an ad for a pending impression, such as the impression associated with web page 125b. The indication may be in the form of bids 135 and 145. The script 129 may poll each of the servers 130 and 140 by sending a request (e.g., a message) to solicit a bid for the impression (e.g., web page 125b).

The servers 130 and 140 may evaluate the impression by directly accessing context information associated with computer 110, browser 115, or a corresponding user (e.g., IP addresses and related demographics, cookie information from past interactions with each of the servers 130 and 140, as well as other information at server 120 provided through script 129, such as information identifying the location of the web page where the impression is occurring). The servers 130 and 140 may then respond with messages providing bids to script 129. The bids may be in any form indicative of an interest to place an ad. For example, the bid may be a simple yes or no indication, a monetary value (e.g., Dollars or Euros), a score, or a prediction of how well the ad will do if placed. The script 129 evaluates the bids and selects an ad to place in the impression (in this case, web page 125b). For example, script 129 may reject both bids and select a default ad previously selected by server 120, select the highest bidder, or select a lower valued bidder (e.g., when a preferred advertiser has a lower monetary bid).

The selected ad may then be provided, either directly as HTML or by reference (e.g., a hyperlink to another server), to computer 110. The browser 115 may then present the selected ad by, for example, rendering the selected ad in a frame of web page 125b. Although the previous example describes the ad as being included within a frame of browser 115, the ad may be presented to a user of computer 110 and browser 115 in a variety of ways including one or more of the following: as a pop-up window, as an email, as a phone call, as visual content, as audio content, embedded in a video, embedded in television, embedded in a mobile device (e.g., a mobile phone or the like), embedded in map data, and any other presentation mechanism. The script 129 thus enables selection of ads on a per impression basis and enables servers to place bids on those ads on a per impression basis. Moreover, since script 129 polls servers 130 and 140, servers 130 and 140 may each directly access the context information independently of other servers. The servers 130 and 140 may thus independently gather whatever information they deem relevant to making a bid.

In some implementations, the server 120 may be implemented as a so-called “publisher” (also referred to as a publisher server or web site) that publishes information content, such as web pages. An example of a publisher is Yahoo, MSN, or any other web site that provides information content. In some implementations, the server 120 may not be a so-called publisher. When that is the case, the server 120 may receive redirects from other servers and then insert, using script generator 127, scripts (e.g., script 129) into a web page that is served to browser 115 or computer 110. The server 120 may also include an ad server for serving ads as well as scripts, such as script 129.

The server 120 may also function as a controller (also referred to as an “active server”) that actively controls ad placement. When that is the case, server 120 may use accounting component 128 to track which ads are inserted into web page 125b, so that the appropriate advertiser can be billed for selected ads.

In some implementations, servers 130 and 140 may be implemented as ad servers for advertisers (and advertising networks) bidding on impressions. Moreover, system 100 may provide a real-time bidding exchange that dynamically optimizes the value of each impression. The system 100 allows the advertiser (e.g., servers 130 and 140) to directly access a user's browser 115 and computer 110 using standard Internet protocols, which allow server 110 to obtain various context information that the advertiser would otherwise only have access to after having secured an impression from an ad server.

An example of context information is cookie information previously recorded to computer 110 by another server, such as server 130, during interactions with browser 115. The cookie information may include any information known to the advertiser about the computer 110 or browser 115, such as ads already shown to the user of browser 115, whether a user clicked on any of those ads or completed a sale as a result of being shown one of those ads, websites (affiliated with server 130) that the user has visited or made a corresponding purchase, and the like. Another example of such context information is the IP (Internet Protocol) address assigned to computer 110, which can be used to infer information such as the physical metropolitan area where the computer is located and the type of connection (e.g., a cable modem, DSL (Digital Subscriber Line) line, dialup modem, T-1 line, and the like) being used to connect computer 110 to the Internet (e.g., network 152). Other examples of context information available to the advertiser are the type of operating system being used at computer 110, the type of browser 115 being used at computer 110, the language preference selected at computer 110, and other such technical details about the configuration of computer 110 and browser 115.

Moreover, server 120 may also include information in script 129 that might be relevant to advertisers (or their servers, such as server 130 and 140). The script 129 may provide the information to the advertisers when it calls servers 130 and 140. For example, the relevant information might include information about the web page the user at browser 115 is visiting (e.g., that the web site is a personal finance related page) or other information known by server 120 (and placed in script 129) about the user (e.g., that the user is a 25 year-old male interested in movies).

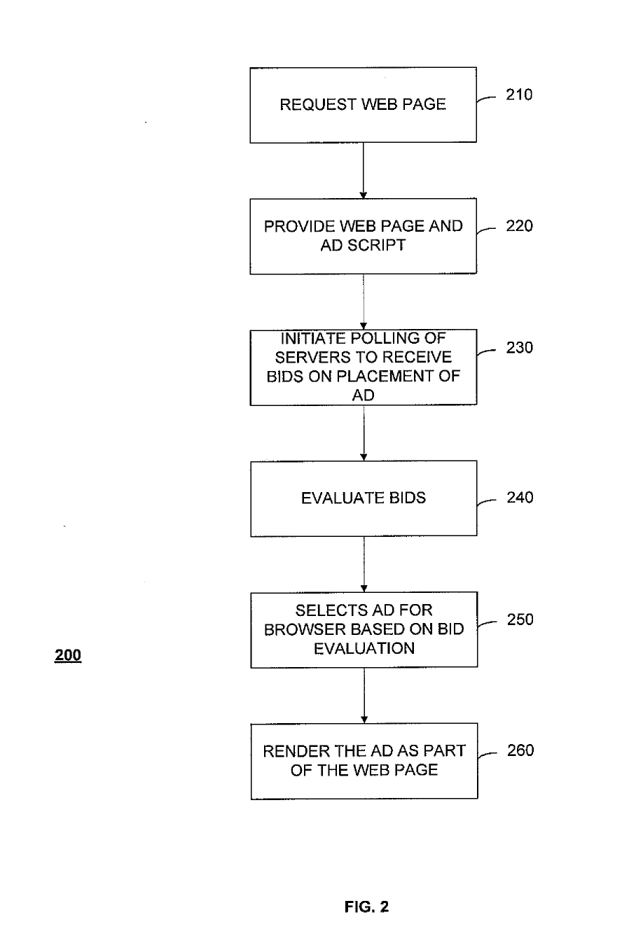

FIG. 2 depicts a method 200 for presenting ads based on bids. Referring to FIGS. 1 and 2, browser 115 requests a web page from server 120 (block 210). At 220, server 120 may respond to the request by providing to browser 115 a web page 125b and a script 129, embedded within web page 125b by script generator 127.

At 230, when web page 125b and script 129 are received at browser 115, script 129 polls one or more servers 130 and 140 to solicit bids for presenting ads associated web page 125b. The script 129 may send one or more messages to poll servers 130 and 140. To enable servers 130 and 140 to assess whether to bid on the impression (e.g., presenting an ad in connection with web page 125b), the messages to servers 130 and 140 may include (or provide access to) one or more of the following: a minimum bid amount, the identity of server 120, the exact page or web site onto which the ad might be served, and context information representative of the user of browser 115 (e.g., identity, demographic information, past interactions with server 120 or other affiliated servers, and past purchases with other affiliated servers known to server 120 at the time it generated script 129). The servers 130 and 140 may then provide bids to script 129. As described above, the bids may be in any form that expresses an interest in presenting an ad. For example, the bid may take one or more of the following forms: a yes indication to present an ad, a no indication rejecting the bid from script 129, and a value in response to the bid message from script 129.

At 240, script 129 evaluates any bids 135 and 145 received from servers 130 and 140, as well as the bid for the so-called default ad provided by server 120 and/or script 129. For example, the default bid may be one (1) cent, bid 135 may be two (2) cents, and bid 145 may be three (3) cents. In this example, script 129 evaluates the three bids and selects server 140 and ad 147. Although the previous example describes evaluating three bids, more or fewer bids may be evaluated as well.

Moreover, script 129 may include a timeout feature, so that a default ad is selected unless an appropriate bid is received from servers 130 or 140 within a predetermined time limit (e.g., ½ second).

At 250, script 129 may select an ad to provide to browser 115. The selection of an ad may include providing the ad, such as HTML content for the ad or, alternatively, a URL (Uniform Resource Locator) link to the ad. The ad may include a call back to server 120 and possibly a call back to server 130 or 140 in order for servers 120, 130, and/or 140 to properly account for the final disposition of the impression.

At 260, the ad (e.g., ad 147) is then rendered at computer 110 and/or browser 115. The ad may take the form of another script as in 220 (but without a web page) provided by server 130 or 140, which initiates another round of bidding to still other servers. When a user selects another web page from web pages 125a, script generator 127 may dynamically embed another script into the other web page.

In some implementations, HTML scripting technology is used to implement script 129, including JSON (JavaScript Object Notation), DOM (Document Object Model), and AJAX (Asynchronous JavaScript and XML). Although the aforementioned technologies may be used, other technologies may be used to implement script 129. The script 129 may also be generated dynamically, i.e., generated for each impression. Alternatively, the script 129 may not be dynamic, but rather included in a server (e.g., a web site) regardless of whether the server includes a script generator 127. When that is the case, the script may requests bids from the same servers each time until the script is edited or replaced.

The server 120 may also include a yield optimization component to determine which ad to use as the default ad and which servers should be polled by script 129 when soliciting bids for an impression. For example, the yield optimization component may evaluate the user's or browser's past interactions (e.g., purchases) to determine whether to list in script 129 a server for an ad. A yield optimization component uses any of a number of potential methodologies to evaluate available context information about an impression, historical results for the various available ads, and the various requirements of the potential advertisers to determine which ad should be served for an impression or which ad and bidders should be included in a script, such as script 129. Yield optimization may be implemented as a component of an ad server, and ad servers may make decisions about ads to serve without utilizing yield optimization using any other decision methodologies.

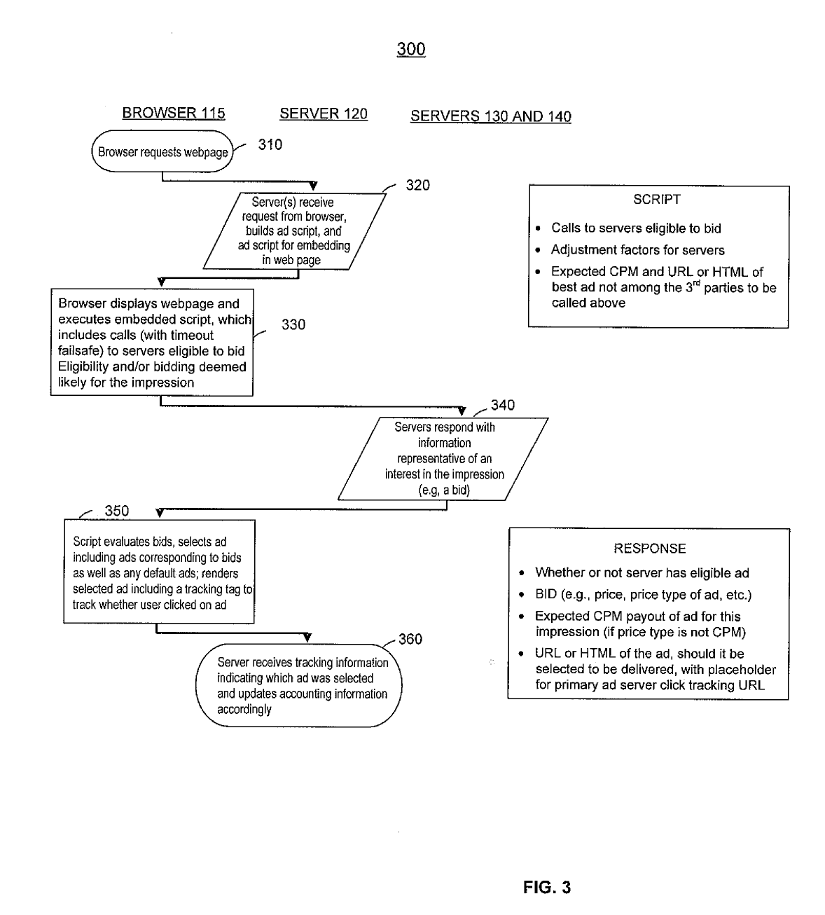

FIG. 3 depicts another method 300 for presenting ads based on bids. At 310, browser 115 requests a web page from a server, such as server 120. In the implementation of FIG. 3, server 120 is implemented as a publisher server that provides web pages to browsers, although other types of servers may be used.

At 320, server 120 may receive the request from browser 115, build script 129 using script generator 127, and return web page 125b and script 129 to browser 115 through network 152. In some implementations, script 129 is generated dynamically for each user request for a web page. When that is the case, server 120 may provide script 129 that is yield optimized for that specific impression. For example, based on the type of impression and the particular user, server 120 may select a default ad with the greatest predicted performance of such ads available to server 120, select bidders most likely to bid on the impression, and include the selected default ad and the selected bidders in script 129. In other implementations, the script 129 is not generated dynamically but rather hard-coded into web pages 125a and 125b.

The script 129 may include the code necessary to perform one or more of the following: polling of the servers (including URLs to locate the servers); receiving bids; evaluating bids; selecting an ad based on the evaluation; and providing (or serving) the appropriate ad content to the browser. The script 129 may also include information about alternative ads should one of the ads from servers 130 and 140 not yield a bid or one of sufficient amount. For example, a default ad may be designated to have a bid value of 5. If bid values of 2 and 4 are received from servers 130 and 140, respectively, script 129 may select the default ad for the impression. The script 129 may also include adjustment factors to be applied to the bids received from servers 130 and 140. For example, a factor may take into account the relative priority for delivery of ads from the different downstream servers 130 and 140 based on factors other than price, such as other elements of the business relationship, past discrepancies in the value of impressions delivered to servers 130 or 140, and the speed that ads are being served from servers 130 and 140. The script 129 may include adjustment factors for different categories of ads. For example, a woman's cosmetic ad may be factored lower than a car tire ad when the impression is for a sports web site. The above-described factors may be used to increase or decrease the value of bids received from servers 130 and 140. The script 129 may also include a URL of a counting web site (or server) to track which ad was selected and any other information desired for tracking ad performance.

At 330, script 129 executes and then calls servers 130 and 140, identified in script 129 as supporting a bid request. The bid request may include information identifying (to servers 130 and 140) the source of the bid request. The bid request may also include (or make accessible) additional information, such as user profile information, cookie information, and the like.

At 340, servers 130 and 140 respond with messages including bids. Before making the bids, servers 130 and 140 receive messages from script 129 (or browser 115) and receive cookies associated with browser 115 and the server receiving the message. The cookies may provide context information, such as the frequency that a browser has seen an ad, user behavior, and other historical information that servers 130 or 140 have known at the time of past communications with computer 110. Each of servers 130 and 140 may then determine pricing (or estimated value) under which they would provide a responsive bid to script 129.

In some implementations, if script 129 provides an estimated price to servers 130 and 140, it may also get the actual price type and price upon which the actual payout will be made. If the price was pre-negotiated on a CPM (cost per thousand impressions) basis, then the response from servers 130 and 140 may be in the form of a yes or no to the impression. Otherwise, the servers 130 and 140 may need to provide an amount with the bids for the impression. But the bid could either be a fixed amount that servers 130 and 140 promise to pay if they get the impression (meaning the bid is also on a CPM basis), or it may just be a soft estimate of how much they will pay. In the case of giving an estimate, servers 130 and 140 may provide the actual price type and price under which the actual payment would be made. Examples of price types include the following: CPM represents a fixed dollar amount per 1,000 impression; CPC represents a fixed dollar amount (cost) per click; CPA represents a fixed dollar (cost) amount per sale (action); CPL represents a fixed dollar (cost) amount per lead; CPV represents a fixed dollar (cost) per view; and CPR (or revshare) represents a fixed percentage of sales value. For example, assume server 130 determines the best ad to serve is an ad for which it will pay $0.25 if the user clicks (e.g., CPC). If the estimated chance that the user will click is 5%, then the estimated value that server 130 will pay for this one impression is $0.0125 (5% multiplied by $0.25, which is a $12.50 CPM). The server 130 is not promising to pay $0.0125 if they get the impression; server 130 is essentially estimating what it is likely on average to pay given a predicted 5% chance of getting a click.

The messages sent at 340 may include one or more of the following: whether or not an ad is available to be placed; the bid (either the actual or estimated amount that will be paid if the bid is won); the actual price type and price should the bid only be an estimate; and a URL or HTML of the ad should it be selected as the winning bid. The servers 130 and 140 may also update (or provide) cookie information at browser 115.

At 350, script 129 evaluates any bids received from servers 130 and 140 by comparing the bids from servers 130 and 140. If the bids from server 130 and 140 do not exceed a threshold value, script 129 may use a default ad identified in script 129 or identified by server 120. Based on the evaluation, script 129 may then select an ad and notify server 120 which ad was selected, so that server 120 and accounting component 128 can track which ad was selected for billing purposes.

In some implementations, script 129 may wait up to a predefined period of time before selecting an ad as part of the bid evaluation described above. If no bids are received within the predetermined time period, script 129 may use a default ad identified in script 129 or identified by server 120.

At 360, server 120 may receive tracking information indicating which ad was selected by script 129. This can be accomplished by having the script send a message from the browser 115 to the server 120 identifying the ad or bidder selected. In addition, the script 129 may include (in the HTML content of the ad or URL link to the ad) an additional URT, that the browser 110 will call in the event that the user clicks on the ad, to facilitate the reporting of such clicks by server 120. The script 129 may also include other information for the advertiser, such as an ID for the advertiser to utilize when reporting back to server 120 any sales that result from serving the ad, in order to track ad performance. In addition, server 130 or 140 may be notified if they are the winning bidder. To that end, servers 130 and 140 may include (in the HTML content of the ad) a URL for browser 110 to call when the HTML content of the ad is served or, alternatively, by counting whether a call at the URL link is received from browser 115. Moreover, script 129 and web page 125b may be implemented in a variety of format including HTML, images, audio, a Flash file, audio, and/or map data.

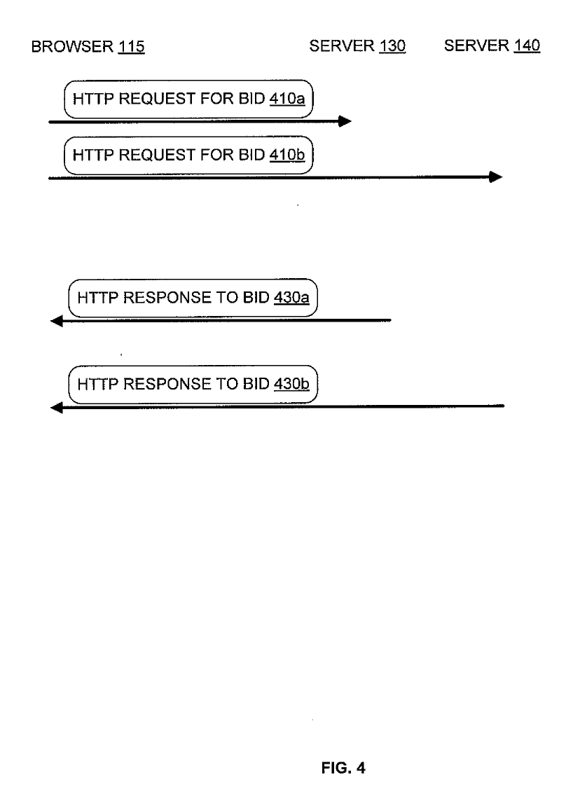

FIG. 4 depicts messages exchanged between browser 115 and one or more servers 130-140. The script 129 at browser 115 sends messages 410a and 410b through network 152 to server 130 and 140. The server 130 is capable of responding to the bid request and thus responds with a message 430a including a bid. The server 140 is also capable of responding to the bid request; server 140 then responds with a response message 430b. The messages 410a-b and 430a-b may be received and or forwarded by one or more of the following: routers, modems, servers, Internet Service Providers, and the like. In some implementations, a response message to a bid request may include information about the bidder's desire to receive more bid requests. For example, the response message may specify a time period for which the bidder does not want to be solicited for another bid. The bid request may include other information that is material to the bidder in preparing a bid response. For example, the bid request may: include information about what type of page or content the user is viewing and/or demographic and past behavioral information known by the publisher about the user; enable a bidder to specify a number of minutes for which they will not be called by the user's browser again for a type of bid; include other miscellaneous information (e.g., information shared with a bidder which may be of help when utilizing the impression); provide the capability to track back what happened in the auction.

Table 1 below lists an example implementation of script 129.

TABLE 1
<script>
/**
Example of Auctioneer code
**/
var C1RTB = {

// Variables will have dynamically generated values. Final

stored information may vary

v1ReserveInfo: {″r″:

{″a″:302230,″c″:249376,″sb″:52320,″ad″:″http://auctioneer.com/bid/td/
?k=yODEwOTsxNzR8OzE7NDQ7Mzc0MzE2Mjs7MTc0NDs7Ozs=data=[DATA]″}},

v4TimeOut:500,
v5InitTime:10,
v6TimeSoFar:10,
v7TimeIncrement:10,
v8Width:300,
v9Height:250,
v12ProtocolVersion:″1″,
v13PubId:19282,
v14PubCatId:1,
v15MaxUrlLength:1024,
time: (new Date( )).getTime( ),
v10BiddersArray: {

″b0Wl2Eh9Pv5Y″:

{″bidurl″:″http://bidder1.com/sz=300x250/loc=6239393/encryption

_version=[ALGORITHM_VERSION].[KEY_VERSION]/rnd=[CACHEBUSTER]/sft=[ENC
RYPTED_SCALE_TIMESTAMP]/pv=[API_VERSION]/dom=[DOMAIN]/callback=[CALLB
ACK]″,

″k″:″NTI2MDI7Mzs2NzQ7MzkzNDI7MDU5MTAuOS44MDI1LmZoLnh6Ljg1LjE5Mk

BAd2hvQEBoZm1tYmV6b3ZAQC0xXzlAQGJ6c2xsIUBAeGxuQEBobGZnc2R2aGc7MTIzNDQ
2MTc0NTU2OTsxOzI2MjE1N3wyMjgxMDk7MTc0fDsxOzQ0OzM3NDMxNjI7Ozs7Ozs=″,

″a″:52602,
″c″:39342,
″sft″:″a8218b8282e92f928d″,
″av″:1,
″kv″:1
},

″b1Pv2Yt9Ji5U″:

{″bidurl″:″http://bidder2.com/getbid/Z=300x250/s=321686/encr_ve

rsion=[ALGORITHM_VERSION].[KEY_VERSION]/_salt=[CACHEBUSTER]/pid=[PUBL
ISHER_ID]/pubcatid=[PUBLISHER_CATEGORY_ID]/r=1/cookie=[COOKIE]/flash=
[FLASH]/avs=[AGE]/gvs=[GENDER]/sft=[ENCRYPTED_SCALE_TIMESTAMP]/protoc
olv=[API_VERSION]/callback=[CALLBACK]″,

″k″:″NzcyMDM7Mzs2NzQ7NjgxOTQ7MDU5MTAuOS44MDI1LmZoLnh6Ljg1LjE5Mk

BAd2hvQEBoZm1tYmV6b3ZAQC0xXzlAQGJ6c2xsIUBAeGxuQEBobGZnc2R2aGc7MTIzNDQ
2MTc0NTU2OTsxOzI2MjE1N3wyMjgxMDk7MTc0fDsxOzQ0OzM3NDMxNjI7Ozs7Ozs=″,

″a″:77203,
″c″:68194,
″sft″:″ba32421b825468d″,
″av″:1,
″kv″:2
}

},

v11GarbageCan: new Array( ),
// [DOMAIN] to be populated by the auctioneer, either server

side,

// or at the browser with a JavaScript function. It is URL-

encoded

dom: ″http%3A//www.google.com″,
headElement:(document.getElementsByTagName(″head″).length ?

document.getElementsByTagName(″head″).item(0) :
document.getElementsByTagName(″html″).item(0)),

```
cookieEnabled:function( ) {
  var cookieEnabled=(navigator.cookieEnabled)? 1 : 0;
  if (typeof navigator.cookieEnabled==″undefined″ &&
```

!cookieEnabled){

document.cookie=″tc″;
cookieEnabled=(document.cookie.indexOf(″tc″)!=−1)? 1 :

0;

```
  }
  return cookieEnabled;
},
flashEnabled: function( ) {
  var flash=new Object( );
  flash.installed=0;
  flash.version=′0.0′;
  if (navigator.plugins && navigator.plugins.length) {
```

for (x=0; x<navigator.plugins.length; x++) {

if (navigator.plugins[x].name.indexOf(′Shockwave

Flash′) != −1) {
flash.version=navigator.plugins[x].description.split(′Shockwave Flash
′)[1];

```
  flash.installed=1;
  break;
  }
```

}

} else if (window.ActiveXObject) {

```
  for (x=2; x<10; x++) {
    try {
```

oFlash=eval(″new

ActiveXObject(′ShockwaveFlash.ShockwaveFlash.″+x+″′);″);

if (oFlash) {

flash.installed=1;

flash.version=x+′.0′;
}
} catch(e) { }

}

```
  }
  return flash.installed;
},
f1CallServer: function(url) {
```

var script = document.createElement(″script″);
script.setAttribute(″type″, ″text/javascript″);
script.setAttribute(″src″, url);
this.headElement.appendChild(script);
return script;

},
f2AllDone: function( ) {

var i;
for (i in this.v10BiddersArray) {

if (this[i] == undefined) return false;

}
return true;

},
// Go through every bidder, check if they responded, collect

the responses to report back,

// compute the winner, display the winner and reports back
// Actual implementation may vary by auctioneer, especially the

part related to

// reporting back of the auction results
f3PickWinner: function( ) {

var i;
var winnerid;
var winnerad;
var winnerk;
var data=″″;
var ja=this.v10BiddersArray;
var rs=this.v1ReserveInfo;
var

jt=″http://auctioneer.com/bid/jt/?k=[WINNERK]data=[DATA]″;

var winnercpm=rs.r.sb;
var maxallowedcpm=200000; // Should be the result of

// 10000 * scaling factor * max ecpm

allowed

// Go through every eligible bidder, check if they

returned,

// determine winner and collect data
for ( i in ja) {

if (this[i] == undefined || this[i].r == undefined

|| this[i].r.sb == undefined || this[i].r.ad == undefined) { //
Bidder timed out or sent a malformed response

data+=ja[i].a.toString(16)+″|″+ja[i].c.toString(16)+″|−1|−1|−

1|−1|−1.″;

continue;

}
// Limit bids to within 0 and maxallowedcpm
if (this[i].r.sb < 0) this[i].r.sb=0;
else if (this[i].r.sb > maxallowedcpm)

this[i].r.sb=maxallowedcpm;

if (winnercpm < this[i].r.sb) {

winnercpm=this[i].r.sb;
winnerid=i;

}
// Collect bidder information to report back to

auctioneer

data+=ja[i].a.toString(16)+″|″+ja[i].c.toString(16)+″|″+(parseI

nt(this[i].r.sb)).toString(16)+″|″+(this[i].mt==undefined ? 0 :
this[i].mt).toString(16)+″|″+this[i].r.s+″|″+ja[i].t+″|″+ja[i].sf+″.″
;

}
if (winnerid != undefined) { // One of the bidders has

won

winnerad=this[winnerid].r.ad;
winnerk=ja[winnerid].k;

} else { // The reserve has won

winnerad=rs.r.ad.replace(″[DATA]″,data);
winnerk=″″;

}
// Prepare URL to report back the winner to the

auctioneer

jt=jt.replace(″[WINNERK]″,winnerk).replace(″[DATA]″,data);

// Garbage collect script tags
this.f8GarbageCollect( );
// Display the winner ad (either reserve or bidder ad)
this.f4FillIframe(winnerad);
// Track DATA only when winner is a bidder
if (winnerk.length > 0) this.f1CallServer(jt);

},
f4FillIframe: function(url) {

if (document.getElementById)

document.getElementById(″c1IframeId″).contentWindow.location.replace(
url); else window.frames[″c1IframeId″].location=url;

},
f5Poll: function( ) {

if (this.v4TimeOut <= this.v6TimeSoFar ||

this.f2AllDone( )) {

this.f3PickWinner( );
return;

}
this.v6TimeSoFar += this.v7TimeIncrement;
window.setTimeout(″C1RTB.f5Poll( )″,this.v7TimeIncrement);

},
// Call bidders by URL, dynamically replacing placeholders with

appropriate variables

f6CallBidders: function( ) {

var i;
var c=0;
var cookieE=this.cookieEnabled( );
var flashE=this.flashEnabled( );
// Age [AGE] and gender [GENDER] below, are dynamically

inserted at server side

for (i in this.v10BiddersArray) {

var url=this.v10BiddersArray[i].bidurl.

replace(″[CALLBACK]″,″C1RTB.″+i).
replace(″[CACHEBUSTER]″,this.time).
replace(″[COOKIE]″,cookieE).
replace(″[FLASH]″,flashE).
replace(″[AGE]″,″50″).
replace(″[GENDER]″,″0″).
replace(″[PUBLISHER_ID]″,this.v13PubId).

replace(″[PUBLISHER_CATEGORY_ID]″,this.v14PubCatId).
replace(″[ALGORITHM_VERSION]″,this.v10BiddersArray[i].av).
replace(″[KEY_VERSION]″,this.v10BiddersArray[i].kv).
replace(″[API_VERSION]″,this.v12ProtocolVersion).
replace(″[ENCRYPTED_SCALE_TIMESTAMP]″,this.v10BiddersArray[i].s

ft);

var encodedDom = encodeURI(this.dom);
var maxlen = this.v15MaxUrlLength - (url.length-

“[DOMAIN]”.length);

url = url.replace(“[DOMAIN]”, encodedDom.substr(0,

maxlen));

var script=this.f1CallServer(url);
this.v11GarbageCan[c++]=script; // To be garbage-

collected later

}

},
// Actual iframe ID and name are dynamically generated and

randomized

f7CreateIframe:function( ) {

document.write(″<iframe name=′c1IfameId′ id=′c1IframeId′

width=′″+this.v8Width+″′ height=′″+this.v9Height+″′ frameborder=′0′
scrolling=′no′ marginwidth=′0′ marginheight=′0′ topmargin=′0′
leftmargin=′0′ allowtransparency=′true′ ></iframe>″);

},
f8GarbageCollect: function( ) {

var i;
for (i in this.v11GarbageCan) {

this.headElement.removeChild(this.v11GarbageCan[i]);

}

}

}
C1RTB.f7CreateIframe( );
C1RTB.f6CallBidders( );
window.setTimeout(″C1RTB.f5Poll( )″,C1RTB.v5InitTime);
</script>

Table 2 depicts an example of a message including a bid returned from one of the servers, such as servers 130 and 140, to script 129.

TABLE 2
/**

An example of an auctioneer's request to a bidder, after

placeholder expansion:
http://bidder1.com/sz=300x250/loc=6239393/encryption_version=1.1/rnd=
78276872/sft=a8218b8282e92f928d/pv=2/dom=http%3A//www.google.com/call
back=C1RTB.b0Wl2Eh9Pv5Y

An example of a bidder's response with a CPM $2.00 and a scale

factor of 3:

C1RTB.b0Wl2Eh9Pv5Y={“r”:{“sb”:60000,“s”:“6ef801f7621a”,“ad”:“ht

tp://bidder1.com/00004642/300250/6239393/k=NjcwODg3OjI0NjowOjAuMDAwMz
EzMjowLjAwMDMxMzI6MC4wMDAzMTMyOjAuMDAwMjM2MTU6MTox”},“mt”:0};

An example of no bid:
C1RTB.b0Wl2Eh9Pv5Y={ };

**/

Although the above describes only servers 120-140 and computer 110, a plurality of servers and computers may be implemented as well.

Moreover, although the above describes a browser as the user interface to information including ads, other types of user interfaces may be used as well. Moreover, these other types of user interfaces may include script (or code) used to poll servers to solicit bids on ads, receive bids, evaluate bids, select a bid, and/or present the ad of the winning bid, as described above. Moreover, the above-described bidding process may be used in a user interface capable of serving Internet advertisements outside of the browser. For example, the above-described bidding process may be used to select and present advertisements to be displayed within a video or audio player application (e.g. Adobe Flash, Windows Media Player, or iTunes), gaming applications, and calendar applications. In the case of such applications, the script may be embedded as code in the application, so that advertisers can be polled on whether they would like to present an ad. The script (or code) may be used to poll advertisers and an ad may be provided for presentation at the user interface. In the case of a video or audio player application, the ad of the winning bidder may be displayed before, after, or during one or more video or audio programs, and the ad may include one or more of text, graphics, video, and audio.

The subject matter described herein may be embodied in systems, apparatus, methods, and/or articles depending on the desired configuration. In particular, various implementations of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications, applications, components, script, or code) include machine instructions for a programmable processor, and may be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the subject matter described herein may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input. The computer may be implemented as a processor (e.g., a central processing unit or the like), router, or any other device including a processor.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

Although a few variations have been described in detail above, other modifications or additions are possible. In particular, further features and/or variations may be provided in addition to those set forth herein. For example, the implementations described above may be directed to various combinations and subcombinations of the disclosed features and/or combinations and subcombinations of several further features disclosed above. In addition, the logic flow depicted in the accompanying figures and/or described herein do not require the particular order shown, or sequential order, to achieve desirable results. Other embodiments may be within the scope of the claims.

### Broadcast Programming Based Advertisements

Hardware/Software Environment

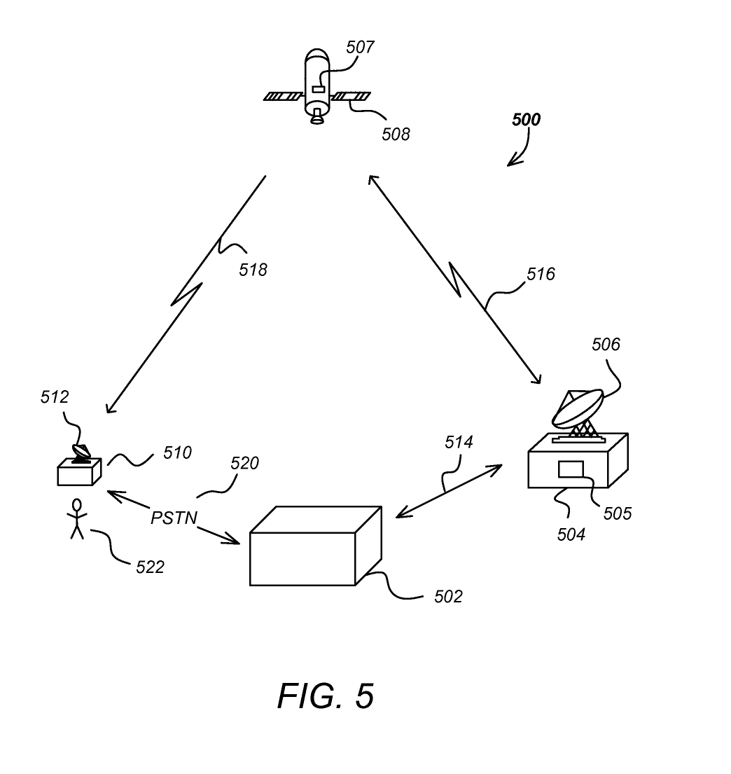

In addition to the embodiments described above, applications for the auction for individual ad impressions may be implemented in a broadcast programming environment. FIG. 5 is an overview of a broadcast programming environment (e.g., a single satellite video distribution system 500) that can be used in accordance with one or more embodiments of the invention. The video distribution system 500 comprises a control center 502 in communication with an uplink center 504 via a ground or other link 514 and with a subscriber receiver station 510 via a public switched telephone network (PSTN) or other link 520. The control center 502 provides program material (e.g. video programs, audio programs and data) to the uplink center 504 and coordinates with the subscriber receiver stations 510 to offer, for example, pay-per-view (PPV) program services, including billing and associated decryption of video programs.

The uplink center 504 receives program material and program control information from the control center 502, and using an uplink antenna 506 and transmitter 505, transmits the program material and program control information to the satellite 508. The satellite receives and processes this information, and transmits the video programs and control information to the subscriber receiver station 510 via downlink 518 using transmitter 507. The subscriber receiving station 510 receives this information using the outdoor unit (ODU) 512, which includes a subscriber antenna and a low noise block converter (LNB).

In one embodiment, the subscriber receiving station antenna is an 18-inch slightly oval-shaped Ku-band antenna. The slight oval shape is due to the 22.5 degree offset feed of the LNB (low noise block converter) which is used to receive signals reflected from the subscriber antenna. The offset feed positions the LNB out of the way so it does not block any surface area of the antenna minimizing attenuation of the incoming microwave signal.

The video distribution system 500 can comprise a plurality of satellites 508 in order to provide wider terrestrial coverage, to provide additional channels, or to provide additional bandwidth per channel. In one embodiment of the invention, each satellite comprises 16 transponders to receive and transmit program material and other control data from the uplink center 504 and provide it to the subscriber receiving stations 510. Using data compression and multiplexing techniques the channel capabilities, two satellites 508 working together can receive and broadcast over 150 conventional (non-HDTV) audio and video channels via 32 transponders.

While the invention disclosed herein will be described with reference to a satellite-based video distribution system 500, the present invention may also be practiced with terrestrial-based transmission of program information, whether by broadcasting means, cable, or other means. Further, the different functions collectively allocated among the control center 502 and the uplink center 504 as described above can be reallocated as desired without departing from the intended scope of the present invention.

Although the foregoing has been described with respect to an embodiment in which the program material delivered to the subscriber 522 is video (and audio) program material such as a commercial or commercial advertisement, the foregoing method can be used to deliver program material comprising purely audio information or other data as well.

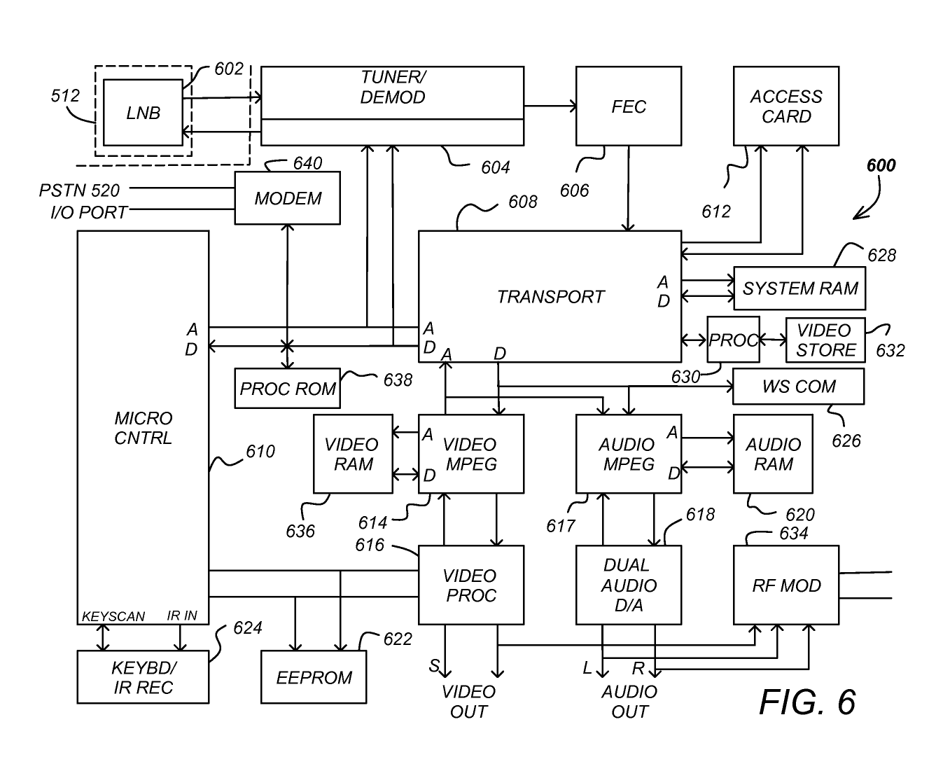

FIG. 6 is a block diagram of an integrated receiver/decoder (IRD) 600 (also hereinafter alternatively referred to as receiver 600 or a set top box). The receiver 600 comprises a tuner/demodulator 604 communicatively coupled to an ODU 512 having one or more LNBs 602. The LNB 602 converts the 12.2- to 12.7 GHz downlink 418 signal from the satellites 508 to, e.g., a 950-1450 MHz signal required by the IRD's 600 tuner/demodulator 604. The LNB 602 may provide either a dual or a single output. The single-output LNB 602 has only one RF connector, while the dual output LNB 602 has two RF output connectors and can be used to feed a second tuner 604, a second receiver 600, or some other form of distribution system.

The tuner/demodulator 604 isolates a single, digitally modulated 24 MHz transponder, and converts the modulated data to a digital data stream. The digital data stream is then supplied to a forward error correction (FEC) decoder 606. This allows the IRD 600 to reassemble the data transmitted by the uplink center 504 (which applied the forward error correction to the desired signal before transmission to the subscriber receiving station 510) verifying that the correct data signal was received, and correcting errors, if any. The error-corrected data may be fed from the FEC decoder module 606 to the transport module 608 via an 8-bit parallel interface.

The transport module 608 performs many of the data processing functions performed by the IRD 600. The transport module 608 processes data received from the FEC decoder module 606 and provides the processed data to the video MPEG decoder 614 and the audio MPEG decoder 617. In one embodiment of the present invention, the transport module, video MPEG decoder and audio MPEG decoder are all implemented on integrated circuits. Such a design may promote both space and power efficiency, and increases the security of the functions performed within the transport module 608. The transport module 608 also provides a passage for communications between the microcontroller 610 and the video and audio MPEG decoders 614, 617. As set forth more fully hereinafter, the transport module also works with the conditional access module (CAM) 612 to determine whether the subscriber receiving station 510 is permitted to access certain program material. Data from the transport module can also be supplied to external communication module 626.

The CAM 612 functions in association with other elements to decode an encrypted signal from the transport module 608. The CAM 612 may also be used for tracking and billing these services. In one embodiment of the present invention, the CAM 612 is a smart card, having contacts cooperatively interacting with contacts in the IRD 600 to pass information. In order to implement the processing performed in the CAM 612, the IRD 600, and specifically the transport module 608 provides a clock signal to the CAM 612.

Video data is processed by the MPEG video decoder 614. Using the video random access memory (RAM) 636, the MPEG video decoder 614 decodes the compressed video data and sends it to an encoder or video processor 616, which converts the digital video information received from the video MPEG module 614 into an output signal usable by a display or other output device. By way of example, processor 616 may comprise a National TV Standards Committee (NTSC) or Advanced Television Systems Committee (ATSC) encoder. In one embodiment of the invention both S-Video and ordinary video (NTSC or ATSC) signals are provided. Other outputs may also be utilized, and are advantageous if high definition programming is processed.

Audio data is likewise decoded by the MPEG audio decoder 617 (e.g., using the audio RAM 620). The decoded audio data may then be sent to a digital to analog (D/A) converter 618. In one embodiment of the present invention, the D/A converter 618 is a dual D/A converter, one for the right and left channels. If desired, additional channels can be added for use in surround sound processing or secondary audio programs (SAPs). In one embodiment of the invention, the dual D/A converter 618 itself separates the left and right channel information, as well as any additional channel information. Other audio formats may similarly be supported. For example, other audio formats such as multi-channel DOLBY DIGITAL AC-3 may be supported.

A description of the processes performed in the encoding and decoding of video streams, particularly with respect to MPEG and JPEG encoding/decoding, can be found in Chapter 8 of “Digital Television Fundamentals,” by Michael Robin and Michel Poulin, McGraw-Hill, 1998, which is hereby incorporated by reference herein.

The microcontroller 610 receives and processes command signals from the remote control 624, an IRD 600 keyboard interface, and/or another input device. The microcontroller receives commands for performing its operations from a processor programming memory, which permanently stores such instructions for performing such commands. The processor programming memory may comprise a read only memory (ROM) 638, an electrically erasable programmable read only memory (EEPROM) 622 or, similar memory device. The microcontroller 610 also controls the other digital devices of the IRD 600 via address and data lines (denoted “A” and “D” respectively, in FIG. 6).

The modem 640 connects to the customer's phone line via the PSTN port 520. It calls, e.g. the program provider, and transmits the customer's purchase information for billing purposes, and/or other information. The modem 640 is controlled by the microprocessor 610. The modem 640 can output data to other I/O port types including standard parallel and serial computer I/O ports.

The present invention also comprises a local storage unit such as the video storage device 632 for storing video and/or audio data obtained from the transport module 608. Video storage device 632 can be a hard disk drive, a read/writable compact disc of DVD, a solid state RAM, or any other storage medium. In one embodiment of the present invention, the video storage device 632 is a hard disk drive with specialized parallel read/write capability so that data may be read from the video storage device 632 and written to the device 632 at the same time. To accomplish this feat, additional buffer memory accessible by the video storage 632 or its controller may be used. Optionally, a video storage processor 630 can be used to manage the storage and retrieval of the video data from the video storage device 632. The video storage processor 630 may also comprise memory for buffering data passing into and out of the video storage device 632. Alternatively or in combination with the foregoing, a plurality of video storage devices 632 can be used. Also alternatively or in combination with the foregoing, the microcontroller 610 can also perform the operations required to store and or retrieve video and other data in the video storage device 632.

The video processing module 616 input can be directly supplied as a video output to a viewing device such as a video or computer monitor. In addition, the video and/or audio outputs can be supplied to an RF modulator 634 to produce an RF output and/or 8 vestigal side band (VSB) suitable as an input signal to a conventional television tuner. This allows the receiver 600 to operate with televisions without a video output.

Each of the satellites 508 comprises a transponder, which accepts program information from the uplink center 504, and relays this information to the subscriber receiving station 510. Known multiplexing techniques are used so that multiple channels can be provided to the user. These multiplexing techniques include, by way of example, various statistical or other time domain multiplexing techniques and polarization multiplexing. In one embodiment of the invention, a single transponder operating at a single frequency band carries a plurality of channels identified by respective service channel identification (SCID).

Preferably, the IRD 600 also receives and stores a program guide in a memory available to the microcontroller 610. Typically, the program guide is received in one or more data packets in the data stream from the satellite 508. The program guide can be accessed and searched by the execution of suitable operation steps implemented by the microcontroller 610 and stored in the processor ROM 638. The program guide may include data to map viewer channel numbers to satellite transponders and service channel identifications (SCIDs), and also provide TV program listing information to the subscriber 522 identifying program events.

The functionality implemented in the IRD 600 depicted in FIG. 6 can be implemented by one or more hardware modules, one or more software modules defining instructions performed by a processor, or a combination of both.

Bidding in the Broadcast Programming Environment

Embodiments of the invention may provide the ability to utilize the real-time bidding mechanism described above in the broadcast programming environment. Programs are delivered via traditional broadcast of the signal (e.g., via control center 502 to uplink center 504, to satellite 508, to subscriber receiver station 510). Programs/content may also be delivered by sending a stream to a particular household (e.g., via vide on demand or when using digital video recorder [DVR] type controls served remotely). In a DVR based system, media content may be stored in video store 632 in an encrypted/unencrypted form that is viewed by the subscriber 522. Such content may be embedded with signals/metadata that identify when dynamically replaceable segments begin and end. Such metadata would be present regardless of whether the program is live from the source (e.g., watching an 8:00 PM EST program at 8:00 PM EST) or watching on demand or time shifted or DVR-type controlled (pause/rewind) programming. Accordingly, in embodiments of the invention video can be played or transmitted over the Internet (e.g., via a website that provides or enables access to such content or via packets to a set top box [e.g., a DVR system that downloads video from the Internet or video on demand services via broadband]).

The signal/metadata can contain information such as the length of time and other restrictions. The IRD 600 would then submit requests to potential advertisers or advertising companies (may be referred to as networks or aggregators) requesting bids for the advertising time. The request may also contain additional information such as the geography and anonymous (or non-anonymous) information about the household (e.g., age, gender, income level, interests, etc.). The request may be received by the actual cable or satellite provider (e.g., internet protocol based services such as U-VERSE™ or FIOS™) that would then syndicate out the requests to the advertising company. Alternatively, the IRD 600 may contact the advertising companies directly. If the cable/satellite provider is contacted, the provider could optionally make the decision as to the winner and transmit instructions back to the IRD 600 (e.g., via downlink 518 or via PSTN 520) to deliver the advertising. Alternatively, the IRD 600 itself may render a decision as to the winner of the bid and retrieve (e.g., from storage 632, from the designated location provider by the advertiser, as broadcast, etc.).

Bid requests and responses may be sent via a two-way cable interface (e.g., PSTN 520). Such bid request/response may be as IP packets or alternative methods that the IRD 600 utilizes to communicate upstream to the provider. Alternatively, a separate Internet connection from the IRD 600 may be utilized, such as through an Ethernet port or WiFi™ connected to the subscriber receiver station 510 home network (e.g., used to support video download, etc.). In yet another embodiment, a two way satellite communication mechanism may be utilized such as through a satellite based Internet connection.

Further, the IRD 600 may provide a mechanism for the user to access the Internet and display resulting information on a television device. In such an embodiment, the IRD 600 may include both satellite/cable boxes or game/system consoles such as the XBOX™, PLAYSTATION™, or NINTENDO WII™ Embodiments of the invention may simply leverage off of such an existing Internet connection (e.g. using an already established TCP/IP connections) to both communicate with advertisers and/or to deliver advertisements. Alternatively, a new separate Internet connection may be utilized (i.e., a separate TCP/IP connection) for the bidding communications. In yet another embodiment, any household Internet connection may be utilized by the IRD 600 for the bidding communications.

Once the auction is complete, the IRD 600 may then request and receive a video stream from the advertising company for the period of time of the advertisement. Such a stream may be processed as described above with respect to FIGS. 5 and 6 or in an alternative distribution mechanism (e.g., using a new or existing Internet connection).

Further, embodiments of the invention may be implemented with a DVR. In such an embodiment, there is an additional option to pre-stage advertising videos (e.g., in video store 632). Such pre-staging may be useful when video content or advertising cannot be streamed (e.g., with older cable networks or some satellite based embodiments). To pre-stage advertising content, the advertising companies may provide/deliver the advertisements (that the advertising company will bid for placement) ahead of time and the IRD 600 will store such content into a reserved (e.g., hidden) space on the DVR (e.g. in video store 632 in encrypted form). Such storage and processing may be optimized by maintaining a knowledge base regarding desired targeting (e.g., potential recipients/subscriber receiver stations 510 that the bidder will bid for placement of an advertisement/impression) and only loading/pre-staging advertisements onto the DVRs of subscriber receiver stations 510 that the advertising company will be bidding for with that particular advertisement. Bidding may then occur as planned.

Alternatively, the advertisement may take many different forms (i.e., other than strictly video or audio content. For example, the advertisement may be displayed outside of the content itself. In this regard, content may be displayed inside of a frame and the advertisement may be displayed on the frame itself all around the content. Such an advertisement could be anything (e.g., text, video, static images, etc.). Such an advertisement may be enabled via an application for/by the satellite/cable television broadcast provider. Accordingly, once the auction is complete, the IRD 600 may request and receive (or retrieve from a pre-staged area) the advertisement in whichever form it is to be displayed to the user.

To enable the bid processing as described above, the microcontroller 610 in IRD 600 may be utilized to process the bidding instructions. Such bidding instructions may be permanently stored in ROM (e.g., ROM 622) or may be stored in CAM 612 and then processed within IRD 600. Alternatively, a processor may exist within CAM 612 that can be configured to process the bidding application. Further, the actual advertisements may be stored within CAM 612.

### Thin-Client Device Based Advertisements

As used herein, thin client devices include cellular devices, cellular phones, personal digital assistants, music players (e.g., IPOD™, IPOD TOUCH™, Blackberry™), WinCE™ devices, or any small handheld type devices with a limited or full processing capabilities. Traditionally, such hand-held devices are limited in their processing and memory capabilities. However, this invention is not intended to be limited to such devices and is intended to include any small or handheld devices regardless of their processing capabilities or memory capacity. The description herein is also directed towards the exemplary cellular/wireless phone based environment. However, embodiments may also be implemented in any type of network or system capable of transmitting content and advertisements.

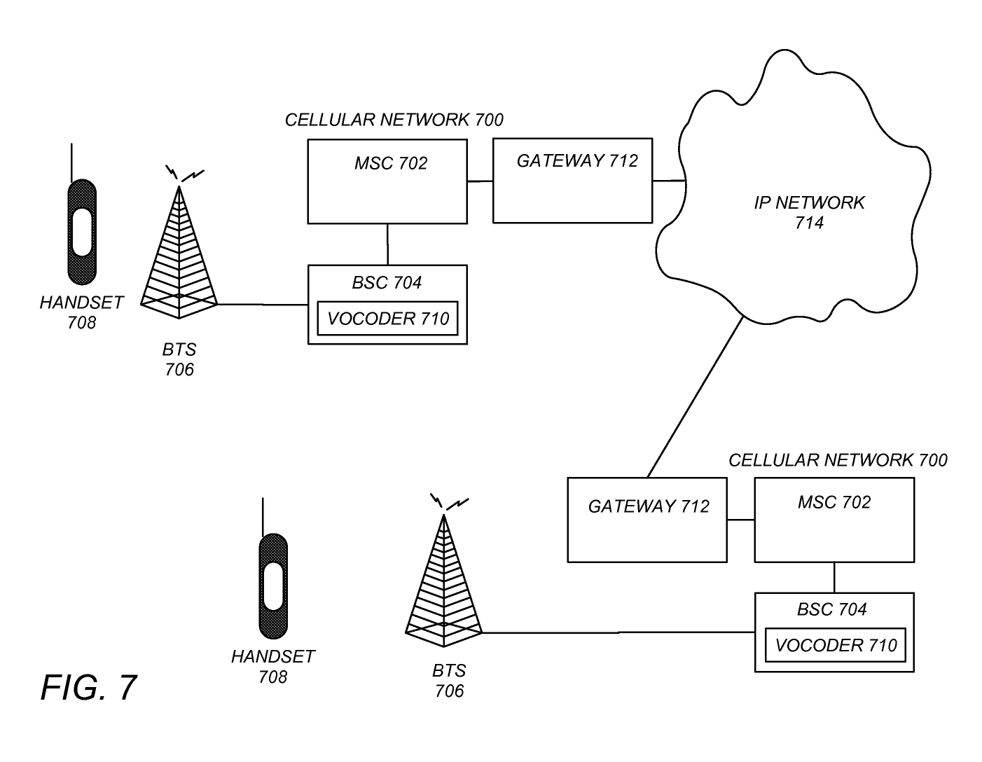

FIG. 7 illustrates an exemplary network configuration that could be used to provide inter-network communications. This exemplary network configurations may be comprised of interconnected cellular networks (e.g., AMPS, GSM, TDMA, or CDMA cellular networks), public land mobile networks (PLMNs), public switched telephone networks (PSTNs), and Internet Protocol (IP) networks.

In the example of FIG. 7, a cellular network 700 includes at least one MSC (Mobile Switching Center) 702, at least one BSC (Base Station Controller) 704, and at least one BTS (Base Transceiver Station) 706 for communicating with one or more handsets 708 or other transceivers. The BSC 704 includes a vocoder 710 for encoding and decoding voice signals received from and sent to the handset 708. The MSCs 702 of two different cellular networks 700 each connects to a separate Gateway 712 that interfaces into an IP network 714. In this manner, the cellular networks 700 communicate across the IP network 714. Also, in one embodiment, the cellular networks 700 themselves may be IP networks.

Video applications may be utilized on any thin client devices including handsets 708. Further, video may be streamed to such thin client devices using the cellular network 700 or other IP network. Commercials and/or advertisements may be streamed at the beginning, middle, or end of such a video stream (e.g., similar to traditional television advertisements). Internet access may also be provided to thin client devices (e.g., via cellular network 700 to handsets 708, or via a WiFi or cabled connection). Such an Internet connection may be utilized to deliver advertisements/advertisement impressions/commercials to thin client devices.

Further, advertisements that are displayed on such thin client devices may be ads within/or enabled by various applications on/for the browser on the thin client device. For example, a live map application showing the user's proximity to various restaurants may send out an RTB request noting the user's exact location and interest in restaurants asking for bids from advertisers (like local restaurants) wishing to show an advertisement across the bottom of the map to this user. Such an advertisement may constitute a discount coupon valid for the subsequent sixty (60) minutes to a restaurant one (1) block away. Accordingly, similar to the broadcast programming environment, the advertisement may not be limited to an audio/video form but may be displayed in a frame around an application and may consist of text, video, static images, etc.

In addition, bidding software (e.g., a script or application) may be installed or transmitted to the thin client device (e.g., using an existing Internet connection or as part of content that is streamed to the thin client device). Similar to the transmissions described above, the bid process may be directly invoked from the thin client device to obtain bids from one or more advertisers. The bidding communications between thin client device and advertiser may be utilized via an Internet connection of the thin client device (e.g., via cellular network 700). In this regard, applications on thin client devices enable the dynamic real-time bidding for advertising as described above.

In yet another embodiment, a remote feature activation message may be utilized to either invoke the bidding process or receive a selected advertisement. To better understand how remote feature activation messages operate, a more detailed description of cellular phone services is useful.

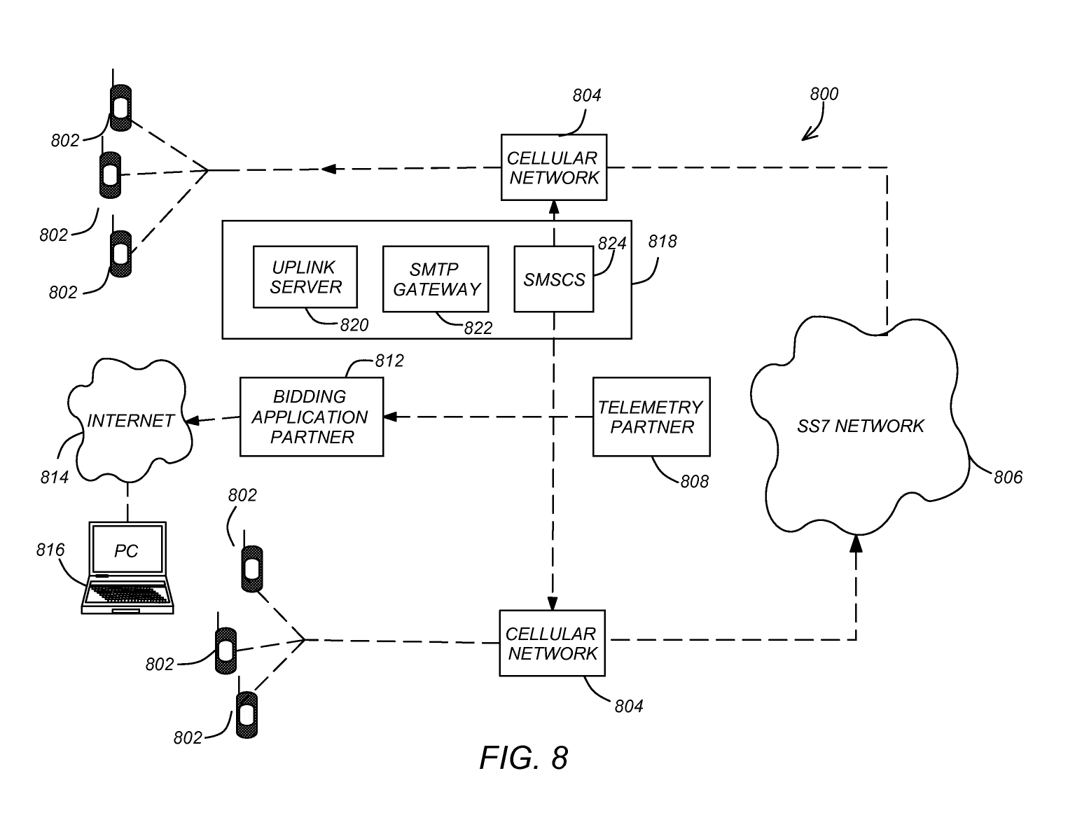

FIG. 8 illustrates a phone system 800 in accordance with one or more embodiments of the invention. The cellular phones/handsets 802 are interconnected and controlled by a central Mobile Telecommunications Switching Office (MTSO) across a signaling system 7 (SS7) network 806. The MTSO is basically a telephone switching office as far as hardware is concerned, but includes a substantial amount of additional digital equipment programmed for cellular control. The MTSO not only connects the system 800 to the land telephone network (the SS7 network 806), but also records call information for billing purposes. SS7 is the protocol used in the public switched telephone system for setting up calls and providing services. SS7 sets up and tears down the call, handles all of the routing decisions, and supports all modern telephony services such as 800 numbers, call forwarding, caller ID, and local number portability (LNP).

A cellular network 804 provides cellular service in a particular region or area and may include one or more MTSOs to provide the cellular service. A cellular phone 802 is associated with a particular cellular network 804 as a home location/area. When a cellular phone 802 is taken outside of the home location or into another cellular network 804 area, the cellular phone 802 is “roaming”. The interim standard-41 (IS-41) is the protocol for passing cellular subscriber information from one carrier/cellular network 804 to another to provide roaming capabilities. Accordingly, IS-41 allows mobile travelers to roam across the country.

A message must be sent from a cellular phone 802 to the phone's 802 serving home location register before service is allowed when roaming. Such a message registers the phone in the foreign cellular network 804. When the cellular phone 802 is taken into a foreign cellular network 804, a message is transmitted to an MTSO in the foreign network 804. The foreign network 804 recognizes that the cellular phone 802 is from a different network and requests validation of the phone's 802 service from the phone's 802 home cellular network 804. Once validated, the cellular phone 802 is permitted to make and receive calls while in the foreign network 802.

Various methods of transmitting and various types of telemetry messages may leverage the IS-41 protocol and SS7 network to provide the bidding system in accordance with embodiments of the invention. A telemetry message such as a registration notification message or remote feature activation message may be utilized to initiate a real-time dynamic bid/auction process on cellular network 804. When a cellular phone 802 moves to a different cellular network 804 or powers on or off the cellular phone 802, a telemetry message is delivered to the appropriate cellular network 802. Once a cellular network 804 receives a telemetry message, the message can be forwarded, reformatted, or generally acted upon in some manner.

In one embodiment of the invention, a remote feature activation telemetry message is transmitted. A remote feature activation message comprises data encoded in a field (e.g., a dialed digits field) of a message. With the remote feature activation message, a fictitious area code (e.g., 175) is programmed into a cellular phone/radio 802. When attempting to send data, the fictitious area code is preceded by the star character (*) (e.g., *175). This combination identifies to the cellular system 804 that the customer desires to activate or deactivate a feature (e.g., call forwarding, call waiting, etc.). Since a fictitious area code is used (i.e., an area code other than the cellular network's 804 area code), the cellular network 804 interprets the cellular phone 802 as a roaming cellular phone 802 desiring to activate or deactivate a feature (e.g., call forwarding, call waiting, etc.). Since a fictitious area code is used (i.e., an area code other than the cellular network's 804 area code), the cellular network 804 interprets the cellular phone 802 as a roaming cellular phone 802 desiring to activate/deactivate a feature and routes the message (*XX175 followed by data) over the SS7 network 806 to the cellular phone's 802 home cellular network 804/location register. The home cellular network 804 is identified by the area code. Accordingly, an independently maintained system 804, at the specified area code, that provides the bidding system functionality is forwarded the telemetry message. By leveraging the fact that a request has to go to the serving home cellular network 804, data (e.g., advertising content, location, user information, bidding information, etc.) may be added into the telemetry message.

While messages are being transmitted to and from cellular phone 802, a unique message is sent from the foreign cellular network 804 to a telemetry partner's 808 home location register (HLR) (e.g., in the area code or home cellular network 804 specified by the telemetry message) that contains information regarding the bidding/auction as well as the cellular phone number of that customer. The message is forwarded to a bidding application partner 812 (e.g., advertising server, web publisher, etc.) 812.

Accordingly, the remote feature activation message or an application on a mobile device 802 or thin client may enable an auction for advertising that is displayed or played back on the mobile device 802 or thin client. Such advertising may be audio, video, or a single frame (e.g., a single image or impression) that is displayed as part of content on the thin client device (e.g., on a media content application executing on the thin client device [such as an internet browser, video player, or other application]). Further, such bidding and messages occur in real time on a dynamic basis (as described above).

### Server-to-Server Real-Time Bidding

As an alternative to the above-described embodiments, the advertisement and bidding process may occur in real time/dynamically between two servers 120-140. In other words, the dynamic real-time bidding process may operate between an end-user device (e.g., thin client device, set-top box, web-browser, etc.) and a server 120-140, or between two servers 120-140. In a server-to-server based environment, a request for a web page is received from a user (e.g., via a set top box, thin client device, web browser, etc.) at a server (e.g., web-site host, web publisher, cellular network 700/804, control center 502, uplink center 504, etc.). Rather than basing the inserting of an advertisement on advance bids provided by other servers 130-140, the server 120 initiates a real-time bid/auction for an impression to be served to the user.

The real-time/dynamic bid/auction may transmit a variety of types of information to the servers 130-140 to solicit the bids. Such information may include information about the user (e.g., prior bidding experiences known by the server 120, particular user based information based on a cookie, IP address information, GPS based location, etc.). Further, the server 120 may attempt to provide servers 130-140 with as much information as possible to allow servers 130-140 to determine the identity of the user or as much information as needed by servers 130-140 to determine and provide a bid 135-145 to server 120.

In view of the above description and flow chart illustrated in FIG. 3, a server-to-server based embodiment enables server 120 to perform the prior browser based steps of 330, 350, and 360. Accordingly, in addition to user based information, server 120 may execute calls to numerous servers 130-140 that are eligible to bid (with timeout failsafe). Servers 130-140 respond to server 120 with information representative of an interest in the impression (e.g., a bid) at 340. Such a bid indicates whether the server 130-140 has an eligible ad, the actual bid (e.g., price, price type of ad, etc.) the expected CPM payout of the ad for this impression (if the price type is not CPM), an a URL or HTML of the ad (should the ad be selected to be delivered, with placeholder information for primary ad server click tracking URL).

At 350, the server 120 evaluates bids, selects one or more advertisements to utilize in the impression (including advertisements corresponding to bids as well as any default ads), and inserts the appropriate information into the information/page (e.g., into the streamed content, static web page, dynamic web page, broadcast program, etc.). The information/page is then delivered to the user in the appropriate format (e.g., via a cellular network, internet transmission, broadcast, etc.). The end user then displays the information (e.g., on the thin client device, television, LCD monitor, etc.).

Accordingly, rather than merely basing the advertising that is used for an impression on advanced bids that are made by servers 130-140 without real-time information about the user that will be viewing the advertisement, embodiments of the invention provide the ability to conduct a real-time bid/auction that is conducted dynamically with the user's request for the advertisement. The bidders receive information useful to optimize their return on investment (by utilizing the end-user's information to better predict a response to the advertisement), and bids are executed via real-time exchange between multiple servers. Such an embodiment would not require the use of a script (e.g., with the bidding information) or other program that is inserted into content that is transmitted to the end user. Instead, the server 120 controls the bidding process and merely delivers the content that includes the impression (from the winning bidder).

### Logical Flow

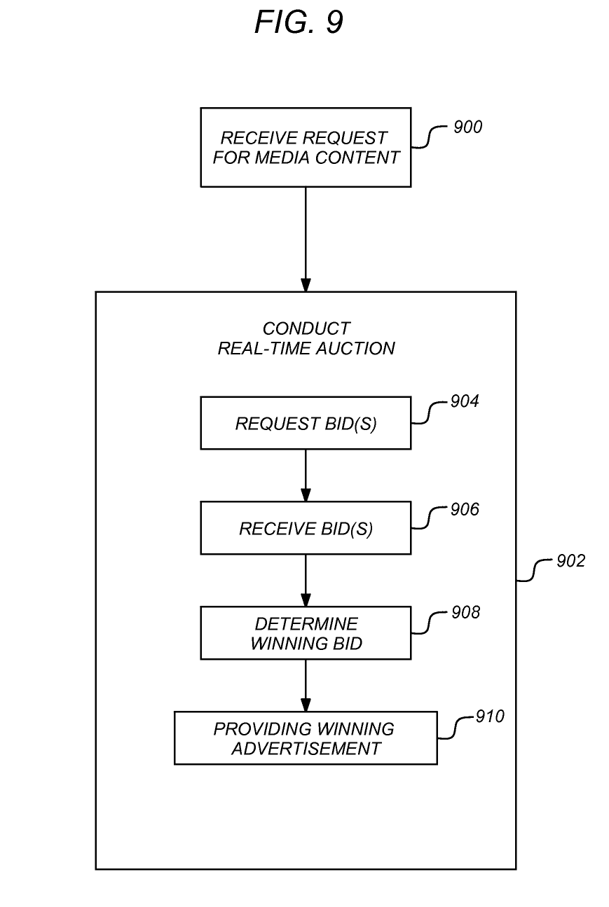

FIG. 9 is a flow chart illustrating the logical flow for selecting media content (e.g., an advertisement) to be displayed by a user in accordance with one or more embodiments of the invention. At step 900, a request is received, from a particular user device, for media content. Such a request may be received by a user device itself (e.g., a subscriber receiver station, thin client device, web browser, etc.). Alternatively, the request may be received by a content provider (i.e., from a user device).

At step 902, in response to the received request, a real-time auction, for an advertisement to be displayed with the media content via the particular user device, is conducted. The real-time auction can be conducted between a server and the bidders or between the end-user device and the bidders. For example, a content provider that receives the request for the media content (from the particular user device) may conduct the auction directly with the one or more bidders. Alternatively, the content provider may receive the request for media content and provide/transmit instructions/information that enables the particular user device to dynamically conduct the real-time auction. What is noteworthy in both situations is the fact that the auction is being conducted dynamically in real-time after the request for media content has been received. In other words, the auction is not conducted in advance of receiving the media content request. In this regard, information about the particular user device that will be displaying/playing the advertisement may be utilized by the bidders to determine the appropriate bid.

As illustrated in FIG. 9, such an auction includes steps 904-910.

At step 904, a bid is dynamically requested from one or more bidders for an advertisement to be presented on the particular user device.

At step 906, one or more bids are received in real-time from the one or more bidders.

At step 908, a determination is made regarding which of the bidders has won the auction based on the bids received.

At step 910, a winning advertisement is provided to be displayed with the media content.

In one or more embodiments, the particular user device is a subscriber receiver station (e.g., in a cable or satellite broadcast based system) and the request for media content is received at 900 by a broadcast programming provider. In response to the request for media content, the subscriber receiver station receives broadcast media content from the broadcast programming provider that includes an advertising signal identifying a dynamically replaceable segment of the media content. The subscriber receiver station then conducts the real-time auction at step 904 by communicating directly with the bidders based on the advertising signal received. In addition, rather than receiving the advertisement in real-time (or in addition to such transmission/broadcast in real-time), the subscriber receiver station may pre-stage the advertisement.

As an alternative to the subscriber receiver station conducting the real-time auction, the auction may be dynamically conducted in real-time by the broadcast programming provider who communicates directly with the bidders to select the winning bid/advertisement. The provider could then either broadcast the media content including the winning ad to the subscriber receiver station, transmit the ad directly to the subscriber receiver station, or broadcast the media content with a signal identifying the dynamically replaceable segment along with an identification of the winning ad for the subscriber receiver station to insert and display to the user (e.g., on a display device such as a television or monitor).

In yet another embodiment, the particular user device may be a thin client device (e.g., a cellular phone, PDA, IPOD Touch™, etc.) where the real-time auction is conducted over a cellular network. The media content could then be displayed on the thin client device using a media content application executing on the device (e.g., a web browser, application, etc.). Such a real-time auction may be initialized using a remote feature activation message transmitted by the thin client device.

### CONCLUSION

This concludes the description of the preferred embodiment of the invention. The following describes some alternative embodiments for accomplishing the present invention. For example, any type of computer, such as a mainframe, minicomputer, or personal computer, or computer configuration, such as a timesharing mainframe, local area network, or standalone personal computer, could be used with the present invention.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A computer implemented method for selecting media content to be displayed by a user, comprising:
(a) in response to a received request for media content from a particular user device, conducting a real-time auction for an advertisement to be displayed with the media content via the particular user device, comprising:
(i) dynamically requesting a bid from one or more bidders for an advertisement to be presented via the particular user device;
(ii) receiving, in real-time, a bid from the one or more bidders for the advertisement;
(iii) determining which of the one or more bidders wins the auction based on the bids received; and
(iv) providing a winning advertisement to be displayed with the media content.

2. The method of claim 1, wherein the real-time auction is conducted between a content provider that receives the request for the media content and the one or more bidders.

3. The method of claim 1, wherein in response to the request for media content, a content provider that receives the request transmits information to the particular user device that enables the particular user device to dynamically conduct the real-time auction.

4. The method of claim 1, wherein:
(a) the particular user device comprises a subscriber receiver station;
(b) the received request for media content is received by a broadcast programming provider;
(c) in response to the request for media content, the subscriber receiver station receives broadcast media content from the broadcast programming provider, wherein the broadcast media content comprises an advertising signal that identifies a dynamically replaceable segment of the media content; and
(d) the subscriber receiver station conducts the real-time auction by communicating directly with the one or more bidders based on the advertising signal.

5. The method of claim 4, wherein the advertisement is pre-staged in the subscriber receiver station.

6. The method of claim 1, wherein:
(a) the particular user device comprises a subscriber receiver station;
(b) the received request for media content is received by a broadcast programming provider;
(c) in response to the request for media content, the broadcast programming provider conducts the real-time auction directly with the one or more bidders and selects the winning advertisement; and
(d) the broadcast programming provider broadcasts the media content including the winning advertisement to the subscriber receiver station.

7. The method of claim 1, wherein:
(a) the particular user device comprises a subscriber receiver station;
(b) the received request for media content is received by a broadcast programming provider;
(c) in response to the request for media content, the broadcast programming provider conducts the real-time auction directly with the one or more bidders and selects the winning advertisement; and
(d) the broadcast programming provider broadcasts to the subscriber receiver station:
(i) the media content wherein the media content comprises an advertising signal that identifies a dynamically replaceable segment of the media content; and
(ii) an identification of the winning advertisement for the subscriber receiving station.

8. The method of claim 1, wherein:
(a) the particular user device comprises a thin client device;
(b) the real-time auction is conducted over a cellular network; and
(c) the media content is displayed on the thin client device using a media content application executing on the thin client device.

9. The method of claim 8, wherein the real-time auction is initialized using a remote feature activation message transmitted by the thin client device.

10. A system for selecting media content to be displayed to a user comprising:
(a) a broadcast program provider configured to conduct, in response to a received request for media content from a particular subscriber receiver station, a real-time auction for an advertisement to be displayed with the media content via the particular subscriber receiver station, comprising:
(i) dynamically requesting a bid from one or more bidders for an advertisement to be presented via the particular subscriber receiver station;
(ii) receiving, in real-time, a bid from the one or more bidders for the advertisement;
(iii) determining which of the one or more bidders wins the auction based on the bids received; and
(iv) providing a winning advertisement to be displayed with the media content.

11. A system for selecting media content to be displayed to a user comprising:
(a) a particular subscriber receiver station configured to:
(i) request media content from a broadcast programming provider;
(ii) receive broadcast media content from the broadcast programming provider, wherein the broadcast media content comprises an advertising signal that identifies a dynamically replaceable segment of the media content; and
(iii) conduct a real-time auction for an advertisement to be displayed in the dynamically replaceable segment of the media content via the particular subscriber receiver station, wherein the real-time auction comprises:
(1) dynamically requesting a bid directly from one or more bidders for an advertisement to be presented via the particular subscriber receiver station;
(2) receiving, in real-time, a bid from the one or more bidders for the advertisement;
(3) determining which of the one or more bidders wins the auction based on the bids received; and
(4) providing a winning advertisement to be displayed with the media content.

12. The system of claim 11, wherein the advertisement is pre-staged in the subscriber receiver station.

13. A system for selecting media content to be displayed to a user comprising:
(a) a broadcast programming provider configured to:
(i) in response to a request for media content received from a subscriber receiver station, conduct a real-time auction directly with the one or more bidders, wherein the real-time auction comprises:
(1) dynamically requesting a bid directly from one or more bidders for an advertisement to be presented via the particular subscriber receiver station;
(2) receiving, in real-time, a bid from the one or more bidders for the advertisement;
(3) determining which of the one or more bidders wins the auction based on the bids received; and
(ii) broadcast the media content and information identifying the winning advertisement to the subscriber receiver station to be displayed.

14. The system of claim 13, wherein:
(a) the broadcast programming provider broadcasts to the subscriber receiver station:
(i) the media content wherein the media content comprises an advertising signal that identifies a dynamically replaceable segment of the media content; and
(ii) an identification of the winning advertisement for the subscriber receiving station.

15. A system for selecting media content to be displayed to a user comprising:
(a) a thin client device configured to:
(i) request media content over a cellular network; and
(ii) receive the requested media content over the cellular network, wherein the received requested media content includes instructions for conducting a real-time auction for inserting an advertisement into the requested media content that is displayed on the thin client device using a media content application executing on the thin client device, wherein the real-time auction comprises:
(1) dynamically requesting a bid from one or more bidders for an advertisement to be presented on the thin client device;
(2) receiving, in real-time, a bid from the one or more bidders for the advertisement; and
(3) determining which of the one or more bidders wins the auction based on the bids received.

16. The system of claim 15, wherein the real-time auction is initialized using a remote feature activation message transmitted by the thin client device.
